(19) United States
(12) Patent Application Publication
(10) Pub. No.: US 2017/0004848 A1
(43) Pub. Date: Jan. 5, 2017

(54) METHOD FOR DETERMINING ALCOHOL CONSUMPTION, AND RECORDING MEDIUM AND TERMINAL FOR CARRYING OUT SAME

(71) Applicant: FOUNDATION OF SOONGSIL UNIVERSITY-INDUSTRY COOPERATION, Seoul (KR)

(72) Inventors: Myung Jin BAE, Seoul (KR); Sang Gil LEE, Busan (KR); Geum Ran BAEK, Seoul (KR)

(21) Appl. No.: 15/113,764

(22) PCT Filed: Jan. 24, 2014
(86) PCT No.: PCT/KR2014/000726

§ 371 Date: Jul. 22, 2016

(30) Foreign Application Priority Data
Jan. 24, 2014 (KR) 10-2014-0008741

(51) Int. Cl. G10L 25/66; G10L 25/84; G10L 25/21

(52) U.S. Cl. CPC G10L 25/66; G10L 25/21; G10L 25/84

(57) ABSTRACT

Disclosed are a method for determining whether a person is drunk after consuming alcohol capable of analyzing alcohol consumption in a time domain by analyzing a voice, and a recording medium and a terminal for carrying out same. An alcohol consumption-determining terminal comprises: a voice input unit for generating a voice frame by converting an inputted voice signal and outputting the voice frame; a voiced/unvoiced sound analysis unit for determining whether the voice frame inputted through the voice input unit corresponds to a voiced sound, an unvoiced sound, or background noise; a voice frame energy detection unit for extracting the average energy of voice frames which have been determined as a voiced sound by the voiced/unvoiced sound analysis unit; an interval energy detection unit for detecting the average energy of intervals including a plurality of voice frames which have been determined as voiced sounds; and an alcohol consumption determining unit for determining whether a person is drunk after consuming alcohol by extracting a difference value among the average energy of neighboring intervals which have been detected by the interval energy detection unit, thereby determining whether a person is drunk after consuming alcohol by analyzing the voice signal in a time domain.

### TECHNICAL FIELD

The present invention relates to a method of determining whether a person is drunk after consuming alcohol using voice analysis in the time domain, and a recording medium and terminal for carrying out the same.

### BACKGROUND ART

Although there may be differences among individuals, a drunk driving accident is likely to happen when a driver is half-drunk or drunk. As methods of measuring drunkenness, there is a method of measuring the concentration of alcohol within exhaled air during respiration using a breathalyzer equipped with an alcohol sensor and a method of measuring the concentration of alcohol in the blood flow using a laser. Generally, the former method is usually used for cracking down on drunk driving. In this case, when any driver refuses a drunkenness test, the Widmark Equation may be used to estimate a blood alcohol concentration by collecting the blood of the driver with his or her consent.

A technology for determining whether a driver has consumed alcohol and controlled starting device for a vehicle in order to prevent drunk driving is commercialized. Some vehicles to which the technology is applied are already commercially available. Such a technology works by enabling or disabling a vehicle to be started by attaching a detection device equipped with an alcohol sensor to the starting device of the vehicle, this is a field in which much research is being conducted by domestic and foreign automotive manufacturers. These methods use an alcohol sensor and thus may relatively accurately measure a concentration of alcohol. However, in an environment with high humidity and dust, such as an automotive interior environment, the alcohol sensor has a low accuracy and is not entirely usable due to frequent failures. Furthermore, the sensor has a short lifetime. Accordingly, when the sensor is combined to an electronic device, there is an inconvenience of having to repair the electronic device in order to replace the sensor.

### DISCLOSURE

### Technical Problem

An aspect of the present invention is directed to a method of determining whether a person is drunk after consuming alcohol using voice analysis in the time domain, and a recording medium and terminal for carrying out the same.

### Technical Solution

According to an aspect of the present invention, an alcohol consumption determination method includes converting a received voice signal into a plurality of voice frames and extracting average energy for each of the voice frames, dividing the plurality of voice frames into sections with a predetermined length and extracting average energy for a plurality of voice frames included in each of the sections; and comparing the average energy between a plurality of neighboring sections to determine whether alcohol has been consumed.

The converting of a received voice signal into a plurality of voice frames and the extracting of average energy for each of the voice frames may include determining whether each of the plurality of voice frames corresponds to a voiced sound, an unvoiced sound, or background noise and extracting average energy for each voice frame corresponding to the voiced sound.

The comparing of the average energy between a plurality of neighboring sections to determine whether alcohol has been consumed may include setting the neighboring sections to overlap either partially or not at all, extracting average energy for voice frames included in each of the sections, and determining whether a person is drunk after consuming alcohol according to a difference in the extracted average energy.

The comparison of the average energy between a plurality of neighboring sections to determine whether alcohol has been consumed may include determining that alcohol has been consumed when a difference in average energy between the plurality of neighboring sections is less than a predetermined threshold and determining that alcohol has not been consumed when the difference is greater than the predetermined threshold.

According to an embodiment of the present invention, an alcohol consumption determination terminal includes: a voice input unit configured to convert a received voice signal into voice frames and output the voice frames; a voiced/unvoiced sound analysis unit configured to determine whether each of the voice frames corresponds to a voiced sound, an unvoiced sound, or background noise; a voice frame energy detection unit configured to extract average energy of a voice frame that is determined as a voiced sound by the voiced/unvoiced sound analysis unit; a section energy detection unit configured to detect average energy for a section in which a plurality of voice frames determined as voiced sounds are included; and an alcohol consumption determination unit configured to compare average energy between neighboring sections detected by the section energy detection unit to determine whether alcohol has been consumed.

The voiced/unvoiced sound analysis unit may receive a voice frame, extract predetermined features from the voice frame, and determine whether the voice frame corresponds to a voiced sound, an unvoiced sound, or background noise according to the extracted features.

The alcohol consumption determination unit may include a storage unit configured to pre-store a threshold to determine whether alcohol has been consumed and a difference calculation unit configured to calculate a difference in average energy between neighboring sections.

The difference calculation unit may detect an average energy difference between neighboring sections that are set to partially overlap with each other or may detect an average energy difference between neighboring sections that are set not to overlap with each other.

The voice input unit may receive the voice signal through a microphone provided therein or receive the voice signal from a remote site to generate the voice frame.

According to an embodiment of the present invention, a computer-readable recording medium having a computer program recorded thereon for determining whether a person is drunk after consuming alcohol by using the above-described alcohol consumption determination terminal.

### Advantageous Effects

As described above, according to an aspect of the present invention, whether alcohol has been consumed may be determined by analyzing an input voice in the time domain.

### BRIEF DESCRIPTION OF DRAWINGS

FIG. 1 is a control block diagram of an alcohol consumption determination terminal according to an embodiment of the present invention.

FIG. 2 is a view for describing a concept in which voice signals are converted into voice frames by a voice input unit included in the alcohol consumption determination terminal according to an embodiment of the present invention.

FIG. 3 is a control block diagram of a voiced/unvoiced sound analysis unit included in the alcohol consumption determination terminal according to an embodiment of the present invention.

FIG. 4 is a view for describing a section setting operation of a voice frame energy detection unit included in the alcohol consumption determination terminal according to an embodiment of the present invention.

FIGS. 5A and 5B are views for describing a section setting operation of a section energy detection unit included in the alcohol consumption determination terminal according to an embodiment of the present invention.

FIG. 6 is a control block diagram of an alcohol consumption determination unit included in the alcohol consumption determination terminal according to an embodiment of the present invention.

FIG. 7 is a control flowchart showing an alcohol consumption determination method according to an embodiment of the present invention.

### MODES FOR CARRYING OUT THE INVENTION

Hereinafter, exemplary embodiments of the present invention will be described in detail with reference to the accompanying drawings. In adding reference numbers for elements in each figure, it should be noted that like reference numbers already used to denote like elements in other figures are used for elements wherever possible.

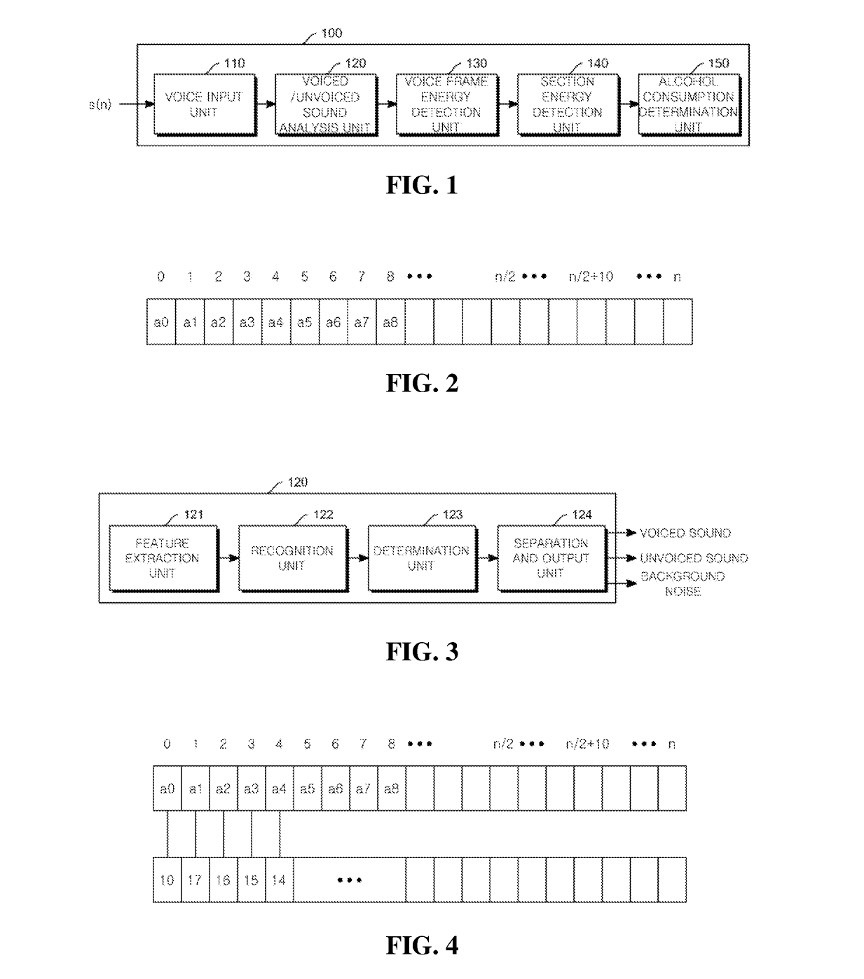

FIG. 1 is a control block diagram of an alcohol consumption determination terminal according to an embodiment of the present invention.

An alcohol consumption determination terminal 100 may include a voice input unit 110 configured to convert received voice signals into voice frames and output the voice frames, a voiced/unvoiced sound analysis unit 120 configured to analyze whether each of the voice frames is associated with a voiced sound or an unvoiced sound, a voice frame energy detection unit 130 configured to detect energy for the voice frame, a section energy detection unit 140 configured to detect energy for a section in which a plurality of voice frames are included, and an alcohol consumption determination unit 150 configured to determine whether alcohol has been consumed using the energy for the section in which the voice frames are included.

The voice input unit 110 may receive a person's voice, convert the received voice into voice data, convert the voice data into voice frames in units of frames, and output the voice frames.

The voiced/unvoiced sound analysis unit 120 may receive a voice frame, extract predetermined features from the voice frame, and analyze whether the voice frame is associated with a voiced sound, an unvoiced sound, or noise according to the extracted features.

The voiced/unvoiced sound analysis unit 120 may determine whether the voice frame corresponds to a voiced sound, an unvoiced sound, or background noise according to a recognition result obtained by the above method. The voiced/unvoiced sound analysis unit 120 may separate and output the voice frame as a voice sound, an unvoiced sound, or background noise according to a result of the determination.

The voice frame energy detection unit 130 may calculate average energy for the voice frame determined as the voiced sound. The average energy is calculated by summing the squares of N samples from short time energy n-N+1 to energy n with respect to sample n, and a detailed description thereof will be provided below.

The section energy detection unit 140 may detect average energy for a section with a predetermined length. The section energy detection unit 140 detects average energy for each of the two neighboring sections.

The alcohol consumption determination unit 150 may calculate a difference in average energy between the two neighboring sections and may determine whether alcohol has been consumed according to the calculated difference.

The alcohol consumption determination unit 150 may compare an average energy difference between the two neighboring sections before drinking and an average energy difference between the two neighboring sections after drinking to determine whether alcohol has been consumed. Here, the average energy difference between the two neighboring sections before drinking may be preset as a threshold and applied in all cases. The threshold may be an optimal value that is set experimentally or customized in advance.

When a person is drunk, his or her ability to control the volume of voice is reduced. Since the person cannot talk smoothly and rhythmically by using a change in energy, the person makes consecutive pronunciations at a loud volume or makes pronunciations at a loud volume when the pronunciation should be made with at a lower volume. Thus, it is determined whether alcohol has been consumed according to an energy change difference in a certain section.

When an energy difference between neighboring sections in a voice frame is smaller than a certain threshold, the alcohol consumption determination unit 150 may determine that alcohol has been consumed.

FIG. 2 is a view for describing a concept in which voice signals are converted into voice frames by a voice input unit included in the alcohol consumption determination terminal according to an embodiment of the present invention.

Typically, analog voice signals are sampled at a rate of 8000 per second and in the size of 16 bits (65535 steps) and converted into voice data.

The voice input unit 110 may convert received voice signals into voice data and convert the voice data into voice frame data in units of frames. Here, one piece of the voice frame data has 256 energy values.

As shown in FIG. 2, the voice data is composed of a plurality of voice frames (n=the number of frames, n=1, 2, 3, . . . ) according to an input voice.

The voice input unit 110 generates a voice frame and then sends information regarding the voice frame to the voiced/unvoiced sound analysis unit 120.

FIG. 3 is a control block diagram of a voiced/unvoiced sound analysis unit included in the alcohol consumption determination terminal according to an embodiment of the present invention.

The voiced/unvoiced sound analysis unit 120 may include a feature extraction unit 121 configured to receive a voice frame and extract predetermined features from the voice frame, a recognition unit 122 configured to yield a recognition result for the voice frame, a determination unit 123 configured to determine whether the received voice frame is associated with a voiced sound or an unvoiced sound or whether the received voice frame is caused by background noise, and a separation and output unit 124 configured to separate and output the voice frame according to a result of the determination.

When the voice frame is received through the voice input unit 110, the feature extraction unit 121 may extract features such as periodic characteristics of harmonics or root mean square energy (RMSE) or zero-crossing count (ZC) of a low-band voice signal energy area from the received voice frame.

Generally, the recognition unit 122 may be composed of a neural network. This is because the neural network is useful in analyzing non-linear problems, that is, complicated problems that cannot be solved mathematically and thus is suitable for analyzing voice signals and determining whether a corresponding voice signal is a voiced signal, an unvoiced signal, or background noise according to a result of the analysis. The recognition unit 122, which is composed of such a neural network, may assign predetermined weights to the features extracted from the feature extraction unit 121 and may yield a recognition result for the voice frame through a calculation process of the neural network. Here, the recognition result refers to a value that is obtained by calculating calculation elements according to weights assigned to features of each voice frame.

The determination unit 123 may determine whether the received voice signal corresponds to a voiced sound or an unvoiced sound according to the above-described recognition result, that is, the value calculated by the recognition unit 122. The separation and output unit 124 may separate and output the voice frame as a voiced sound, an unvoiced sound, or background noise according to a result of the determination of the determination unit 123.

Meanwhile, since the voiced sound is distinctly different from the voiced sound and the background noise in terms of various features, it is relatively easy to identify the voiced sound, and there are several well-known techniques for this. For example, the voiced sound has periodic characteristics in which harmonics are repeated at a certain interval while the background noise does not have the harmonics. On the other hand, the unvoiced sound has harmonics with weak periodicity. In other words, the voiced sound is characterized in that the harmonics are repeated within one frame while the unvoiced sound is characterized in that the characteristics of the voiced sound such as the harmonics are repeated every certain number of frames, that is, is shown to be weak.

FIG. 4 is a view for describing a section setting operation of a voice frame energy detection unit included in the alcohol consumption determination terminal according to an embodiment of the present invention.

The voice frame energy detection unit 130 may calculate average energy for a voice frame determined as a voiced sound. The average energy is calculated by summing the squares of N samples from short time energy n-N+1 to energy n with respect to sample n, and a detailed description thereof will be provided in the following:

$${E}_{n} = \frac{1}{N} \cdot {\sum }_{m = n - N + 1}^{n} {s}^{2} ( m ) . \qquad [ Equation 1 ]$$

Average energy for each of the voice frames determined as voiced sounds may be calculated through Equation 1.

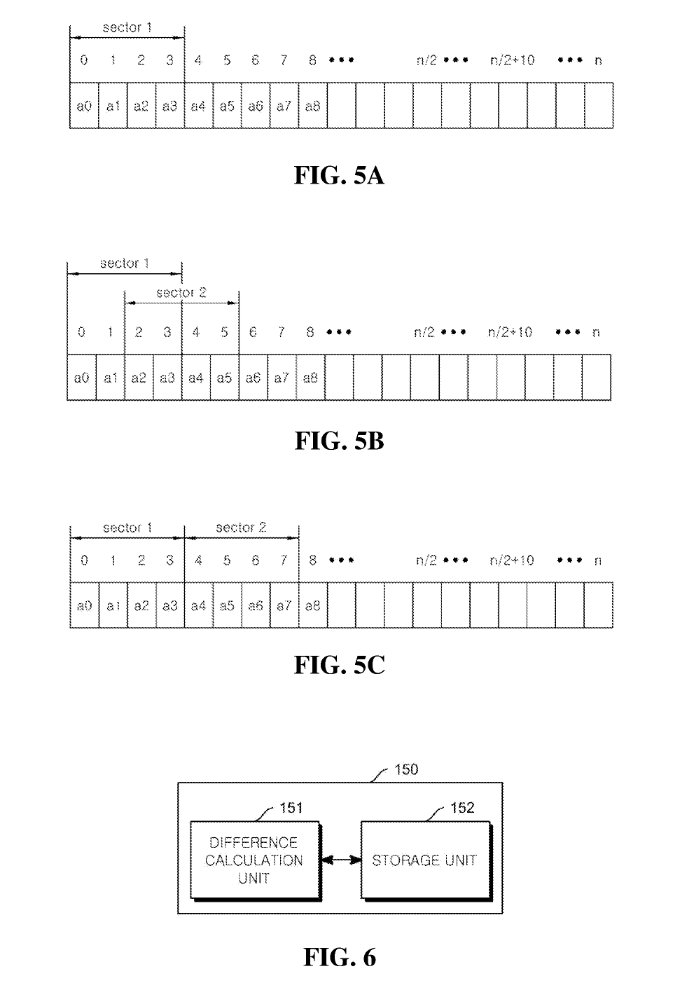

FIGS. 5A to 5C are views for describing a section setting operation of a section energy detection unit included in the alcohol consumption determination terminal according to an embodiment of the present invention.

The section energy detection unit 140 may divide a plurality of voice frames determined as voiced sounds into predetermined sections and may detect average energy for the voice frames included in each of the predetermined sections, that is, average section energy. Since the voice frame energy detection unit 130 calculates average energy for each of the voice frames determined as voiced sounds, the section energy detection unit 140 may detect average section energy using the average energy.

As shown in FIG. 5A, the section energy detection unit 140 may detect average energy for a section with a predetermined length (i.e., sector 1). The section energy detection unit 140 may find average section energy using the following equation:

$${E}_{d} = \frac{1}{{F}_{n}} \cdot {\sum }_{k = 1}^{{F}_{n}} {E}_{n} ( k ) \qquad [ Equation 2 ]$$

where Fn is the number of voice frames in a section, and En(k) is average energy for a k-th voice frame.

The section energy detection unit 140 may detect average energy for two neighboring sections by using the above-described method. Here, the neighboring sections may be implemented in a form in which the voice frames in a certain section partially overlap with each other as shown in FIG. 5B or in a form in which, starting from a frame next to the last voice frame of a certain section, another section is set as shown in FIG. 5C.

FIG. 6 is a control block diagram of an alcohol consumption determination unit included in the alcohol consumption determination terminal according to an embodiment of the present invention.

The alcohol consumption determination unit 150 may include a difference calculation unit 151 configured to calculate a difference in average energy between two neighboring sections and a storage unit 152 configured to prestore a threshold used to determine whether alcohol has been consumed.

The difference calculation unit 151 may calculate the average energy difference between neighboring sections that is transmitted from the section energy detection unit 140 by using the following equation:

ER=α·(E_{d1}−E_{d2})−β [Equation 3]

where Ed1 is average energy for any one section including a plurality of voice frames, and Ed2 is average energy for a section neighboring that of Ed1, and also α and β are constant values that may be predetermined to easily recognize the average energy difference.

In the above embodiments, a difference in average energy between the two neighboring sections has been used. However, it will be appreciated that the average energy may be compared by calculating an average energy ratio between two sections according to an embodiment of the present invention. That is, an embodiment of the present invention may include all methods of comparing average energy between two sections to determine whether alcohol has been consumed.

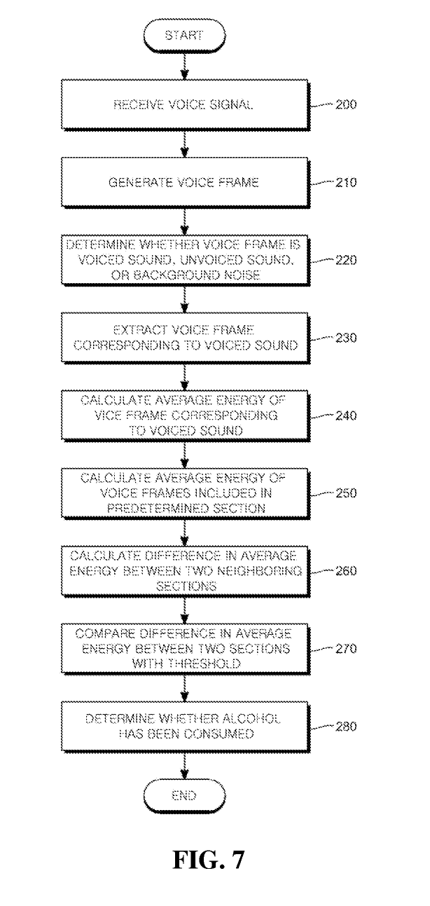

FIG. 7 is a control flowchart showing an alcohol consumption determination method according to an embodiment of the present invention.

The voice input unit 110 may receive a voice from the outside. The voice may be received through a microphone (not shown) included in the alcohol consumption determination terminal 100 or may be transmitted from a remote site. A communication unit (not shown) is not shown in the above embodiment. However, it will be appreciated that a communication unit may be provided to transmit a signal transmitted from a remote site or send calculated information to the outside (200).

The voice input unit 110 may convert the received voice into voice data and convert the voice data into voice frame data. The voice input unit 110 may generate a plurality of voice frames for the received voice and transmit the generated voice frames to the voiced/unvoiced sound analysis unit 120 (210).

The voiced/unvoiced sound analysis unit 120 may receive the voice frames, extract predetermined features from each of the voice frames, and determine whether the voice frame corresponds to a voiced sound, an unvoiced sound, or background noise according to the extracted features. The voiced/unvoiced sound analysis unit 120 may extract voice frames corresponding to voiced sounds among the plurality of voice frames that are received (220, 230, and 240).

The voice frame energy detection unit 130 detects average energy for each of the voice frames determined as voiced sounds (250).

The section energy detection unit 140 detects average energy for each of the two neighboring sections. The alcohol consumption determination unit 150 may calculate a difference in average energy between the two neighboring sections and may compare the calculated difference with a predetermined threshold to determine whether alcohol has been consumed. The alcohol consumption determination unit 150 may determine that alcohol has been consumed when the difference in average energy between the two neighboring sections is less than the threshold and may determine that alcohol has not been consumed when the difference in average energy between the two neighboring sections is greater than the threshold (260, 270, 280, and 290).

In the above method, whether alcohol has been consumed is determined by calculating a difference in average energy between the two neighboring sections. It will be appreciated that a method of calculating and comparing differences in average energy between four sections or another number of sections may be used instead of the two neighboring sections. In addition, it will be appreciated that all methods of comparing average energy among a plurality of sections (e.g., a method of calculating a relative ratio of average energy between two neighboring sections rather than the difference in average energy between the two sections) are included.

Furthermore, it will be appreciated that the alcohol consumption method performed by the above-described alcohol consumption determination terminal 100 may be implemented in a computer-readable recording medium having a program recorded thereon.

Although the present invention has been described with reference to exemplary embodiments thereof, it should be understood that numerous other modifications and variations can be made without departing from the spirit and scope of the present invention by those skilled in the art. It is obvious that the modifications and variations fall within the spirit and scope thereof.

1-10. (canceled)

11. A method for determining whether a person is drunk comprising:
converting a voice signal received from said person into a plurality of voice frames;
extracting a first average energy for each of the voice frames;
dividing the plurality of voice frames into sections with a predetermined length;
calculating a second average energy for a plurality of voice frames included in each of the sections; and
determining whether said person is drunk by computing differences of the second average energy between neighboring sections.

12. The method of claim 11, wherein the converting of a received voice signal into a plurality of voice frames comprises:
extracting predetermined features from a voice frame among the plurality of voice frames, and
determining whether said voice frame is from a voiced sound, an unvoiced sound, or background noise.

13. The method of claim 12, wherein the predetermined features comprise periodic characteristics of harmonics, root mean square energy (RMSE), or zero-crossing count (ZC) of a low-band voice signal energy area.

14. The method of claim 12, wherein the determining whether said voice frame is from a voiced sound, an unvoiced sound, or background noise comprises using neural network.

15. The method of claim 12, wherein the extracting a first average energy for each of the voice frames comprises extracting a first average energy for each voice frame corresponding to the voiced sound.

16. The method of claim 11, wherein the sections, each of which comprises one or more voice frames, either overlap partially or do not overlap with each other.

17. The method of claim 11, wherein the determining whether said person is drunk by computing differences of the second average energy between neighboring sections comprises:
identifying a section and one or more neighboring sections thereof,
computing differences of the second average energy between the identified sections, and
determining whether said person is drunk according to the computed differences of the second average energy.

18. The method of claim 17, wherein the determining whether said person is drunk according to the computed differences of the second average energy comprises:
determining that said person is drunk when a difference in the second average energy between the neighboring sections is less than a predetermined threshold, and
determining that said person is not drunk when the difference is greater than the predetermined threshold.

19. The method of claim 17, wherein the identified sections comprise a section and one neighboring section, and the neighboring section either overlaps partially or does not overlap with said section.

20. A terminal for determining whether a person is drunk comprising:
a voice input unit configured to convert a voice signal received from said person into voice frames and output the voice frames;
a voiced/unvoiced sound analysis unit configured to determine whether each of the voice frames corresponds to a voiced sound, an unvoiced sound, or background noise;
a voice frame energy detection unit configured to extract a first average energy of a voice frame that is determined as a voiced sound by the voiced/unvoiced sound analysis unit;
a section energy detection unit configured to calculate a second average energy for a section in which a plurality of voice frames determined as voiced sounds are included; and
an alcohol consumption determination unit configured to determine whether said person is drunk by computing differences of the second average energy between neighboring sections.

21. The terminal of claim 20, wherein the voiced/unvoiced sound analysis unit comprises:
a feature extraction unit extracting predetermined features from a voice frame among the plurality of voice frames, and
a recognition and determination unit determining whether said voice frame is from a voiced sound, an unvoiced sound, or background noise.

22. The terminal of claim 21, wherein the predetermined features comprise periodic characteristics of harmonics, root mean square energy (RMSE), or zero-crossing count (ZC) of a low-band voice signal energy area.

23. The terminal of claim 21, wherein the recognition and determination unit uses neural network.

24. The terminal of claim 20, wherein the section having one or more voice frames is defined by a predetermined length.

25. The terminal of claim 24, wherein a defined section either overlaps partially or does not overlap with another defined section.

26. The terminal of claim 20, wherein the alcohol consumption determination unit comprises a storage unit configured to prestore a threshold to determine whether said person is drunk and a difference calculation unit configured to compute differences of the second average energy between neighboring sections.

27. The terminal of claim 26, wherein the difference calculation unit computes differences of the second average energy between neighboring sections that partially overlap with each other or between neighboring sections that do not overlap with each other.

28. The terminal of claim 27, wherein the neighboring sections comprise a section selected by the difference calculation unit and one neighboring section thereof.

29. The terminal of claim 20, wherein the voice input unit receives the voice signal through a microphone provided therein or receives the voice signal from a remote site to generate the voice frame.

30. A computer-readable recording medium having a computer program recorded thereon for performing the method of claim 11 to determine whether a person is drunk.
